(19) United States
(12) Patent Application Publication
(10) Pub. No.: US 2026/0113219 A1
(43) Pub. Date: Apr. 23, 2026

(54) DECISION FEEDBACK EQUALISER CIRCUIT

(71) Applicant: WAVE PHOTONICS LIMITED, Cambridge (GB)

(72) Inventors: Timur KELIN, Cambridge (GB); Amir Hossein NEJADMALAYERI, Cambridge (GB)

(73) Assignee: WAVE PHOTONICS LIMITED, Cambridge (GB)

(21) Appl. No.: 19/117,921

(22) PCT Filed: Oct. 3, 2022
(86) PCT No.: PCT/EP2022/077478

§ 371 Date: Apr. 2, 2025

(51) Int. Cl. H04L 25/03; H04L 25/49

(52) U.S. Cl. CPC H04L 25/03057; H04L 25/4917

(57) ABSTRACT

A method of decision feedback equalisation (DFE) of an input signal, comprising: calculating an equalisation range, receiving the input signal; generating an input decision from the input signal; generating a plurality of state decisions from the input signal using the equalisation range and one or more previous input decisions; combining the input decision with the plurality of state decisions to generate a plurality of state complements; selecting a resulting complement from among the plurality of state complements based on one or more previous resulting complements, wherein a number of the one or more previous resulting complements is equal to a number of the one or more previous input decisions; and combining the resulting complement with the input decision to generate an output decision.

### FIELD OF THE INVENTION

The invention generally relates to digital signal processing, particularly decision feedback equalisation.

### BACKGROUND TO THE INVENTION

In the field of signal engineering, equalisation generally refers to a process of removing distortion from a transmitted signal to restore signal clarity. A prominent form of distortion affecting digital signals comprising a sequence of symbols is intersymbol interference (ISI). ISI occurs when the transmission periods of two symbols, consecutive or otherwise, overlap. This may be because the data channel carrying the symbols has an impulse response, resulting in a lingering effect after the transmission of a symbol has finished.

A known method of removing ISI and equalising such a signal is the use of decision feedback equalisation (DFE). In this process, previously transmitted symbols are subtracted from each newly received symbol to correct distortion arising from ISI. The coefficient of each previous symbol in the subtraction may be calculated from the impulse response of the data channel, which is largely constant with time (except for slow effects such as, for example, changes with temperature and/or gradual aging of the data channel).

Constant coefficients, together with a finite number of permitted symbols, mean that the number of possible distortions to a newly received symbol is finite. This permits a method known as speculative DFE, wherein parallel channels are used to subtract each possible distortion from the new symbol. A multiplexer can then select the correct result based on the last few symbols to be received. This minimises the number of operations that need be performed during operation, as the possible distortions can be pre-calculated, allowing for equalisation to be performed with higher symbol rates.

### SUMMARY OF THE INVENTION

The inventors have recognised that speculative DFE has the downside of requiring a large number of parallel channels—one for each possible permutation of recent symbols—resulting in a large number of components, including a large multiplexer, and consequently high power consumption. This issue is especially pronounced when the symbol rate is high (so that more symbols may potentially interfere), or the number of allowed symbols is large (so that there are more permutations requiring separate channels). Therefore, the number of required channels and the resulting power consumption increase rapidly as information is transmitted more quickly.

Embodiments of the present disclosure mitigate this issue by allowing for speculative DFE with a reduced number of channels, and consequently reduced power consumption.

According to one aspect of the present disclosure there is provided a method of decision feedback equalisation (DFE) of an input signal, comprising: calculating an equalisation range, receiving the input signal; generating an input decision from the input signal; generating a plurality of state decisions from the input signal using the equalisation range and one or more previous input decisions; combining the input decision with the plurality of state decisions to generate a plurality of state complements; selecting a resulting complement from among the plurality of state complements based on one or more previous resulting complements, wherein a number of the one or more previous resulting complements is equal to a number of the one or more previous input decisions; and combining the resulting complement with the input decision to generate an output decision.

This method has the advantage that the equalisation range is generally smaller than the full dynamic range of the input signal. Consequently, the number of parallel channels required for DFE, and therefore the size of the multiplexer, may be reduced compared to prior art systems. This in turn leads to reduced power consumption.

The equalisation range may be calculated from an impulse response of the data channel.

The input decision may be a voltage level.

The input decision may be a level of a pulse amplitude modulation scheme.

Generating the plurality of state decisions may comprise: linearly combining the one or more previous input decisions using a set of coefficients calculated from characteristics of the data channel to obtain a first value; in each of a plurality of parallel channels: linearly combining a set of values using the set of coefficients to obtain a channel value, wherein each value in the set of values has magnitude less than or equal to the equalisation range, each value corresponding to a level of a pulse amplitude modulation scheme; combining the input signal, the first value and the channel value to produce a combined value; generating a channel decision from the combined value; wherein the plurality of state decisions comprises each of the channel decisions.

If the equalisation range has a value Δ, and the number of the previous state complements and the number of the previous input decisions is K, the number of the plurality of state decisions may be (2Δ+1)^{K}.

Alternatively, generating the plurality of state decisions may comprise: in each of a plurality of parallel channels: linearly combining a set of values using a set of coefficients calculated from characteristics of the data channel to obtain a channel value, wherein each value in the set of values has magnitude less than or equal to the equalisation range, each value corresponding to a level of a pulse amplitude modulation scheme; combining the input signal with the channel value to produce a combined value; and generating a channel decision from the combined value; wherein the plurality of state decisions comprises each of the channel decisions.

If there are W distinct symbols that may be received as part of the input signal, and the number of the previous state complements and the number of the previous input decisions is K, the number of the plurality of state decisions is N^{K}, and the equalisation range has a value Δ, the method may further comprise selecting (2Δ+1)^{K} of the plurality of state decisions to be combined with the input decision.

The state complement may be further based on the equalisation range.

Each step of combining may refer to either addition or subtraction.

Selecting the resulting complement may comprise combining the plurality of state complements with the equalisation range as well as with the one or more previous resulting complements.

The method may further comprise: for each of the plurality of state complements, for each of the plurality of state complements, determining whether a magnitude of the state complement is less than or equal to the equalisation range; and generating a positive outcome if the magnitude of the state complement is less than or equal to the equalisation range, or a negative outcome otherwise.

The method may further comprise combining the positive and negative outcomes, in which case said combining may comprise the use of logical conjunction circuit, such that the overall outcome is positive if every state complement has magnitude less than or equal to the equalisation range, and negative otherwise.

According to another aspect of the present disclosure there is provided a method of selecting a resulting complement, comprising: calculating an equalisation range, selecting a first plurality of state complements from one or more previous state complements based on the equalisation range; selecting a second plurality of state complements from a plurality of current state complements based on the first plurality of state complements; selecting the resulting complement from among the second plurality of state complements based on one or more previous resulting complements.

According to another aspect of the present disclosure there is provided a decision feedback equalisation (DFE) circuit configured to receive an input signal, the DFE circuit comprising: an input decision circuit configured to generate an input decision from the input signal; a state decision generator configured to generate a plurality of state decisions from the input signal using an equalisation range and one or more previous input decisions; a state complement generator configured to generate a plurality of state complements by combining the input decision with the plurality of state decisions; a multiplexer configured to select a resulting complement from among the plurality of state complements based on one or more previous resulting complements, wherein a number of the previous resulting complements is equal to a number of the previous input decisions; and a combiner configured to combine the state complement with the input decision to generate an output decision.

These and other aspects will be apparent from the embodiments described in the following. The scope of the present disclosure is not intended to be limited by this summary nor to implementations that necessarily solve any or all of the disadvantages noted.

### BRIEF DESCRIPTION OF THE DRAWINGS

For a better understanding of the present disclosure and to show how embodiments may be put into effect, reference is made to the accompanying drawings in which:

FIG. 1 is a block diagram of a prior art decision feedback equalisation (DFE) circuit;

FIG. 2 is a block diagram of a DFE circuit;

FIG. 3 illustrates the dynamic ranges of certain parameters that may be used in DFE;

FIG. 4 is a block diagram of a state decision generator;

FIG. 5 is a block diagram of another state decision generator;

FIG. 6 is a block diagram of a state complement combiner;

FIG. 7 is a block diagram of a quality estimator circuit for use in DFE.

### DETAILED DESCRIPTION

Embodiments will now be described by way of example only.

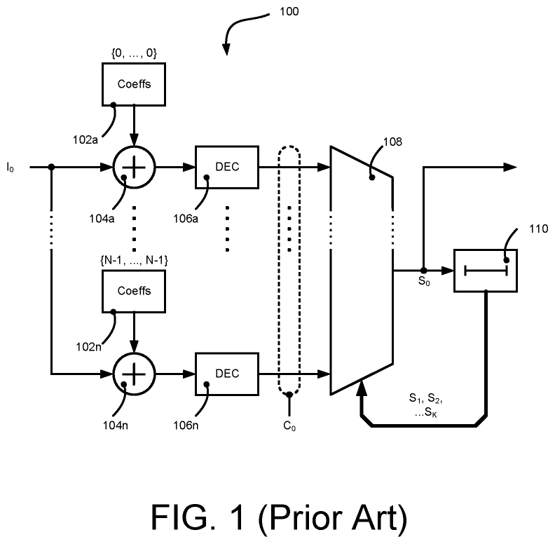

FIG. 1 is a block diagram of a decision feedback equalisation (DFE) circuit 100 according to the prior art. The circuit receives an input signal I₀, which may comprise a symbol, from a data channel. For example, the input signal I₀ may be a voltage level that represents one of N possible symbols in a quantisation scheme. For example, lo may be one of 4 symbols in the PAM-4 scheme. In this specification, symbols are generally referred to by numerals, e.g. 0, 1, 2, 3 for the four symbols of the PAM-4 scheme.

In general, a data channel will have an impulse response with non-zero delay spread. As a result, a signal travelling along a data channel will not remain entirely pure, but will be convolved with the impulse response of the data channel. This may, for example, result in the signal persisting on the channel for longer than the duration of the pure signal.

This convolution of each signal with the impulse response of the data channel means that, at the time when a given signal such as I₀ is received, some number K of previous signals I₁, I₂, . . . , I_{K} may still be present on the channel and result in distortion of I₀. Knowledge of the impulse response function may be used to determine a set of K coefficients (Coeffs) representing the weightings of the K previous symbols mixed with I₀.

In the device 100, I₀ may be split into a number of parallel channels. Each of these channels may comprise a device 102a to 102n that is used to generate a possible distortion to I₀. This may be done by taking each possible permutation of K symbols in the appropriate quantisation scheme, and combining them using the calculated coefficients. Since there are N permitted symbols, the number of parallel channels may therefore be N^{K}.

For brevity, let the W symbols in a quantisation scheme be represented as the numerals 0 to N−1 (which may, for example, represent voltages 0 V to N−1 V). The first parallel channel may then combine K instances of the first symbol, 0. This is represented in FIG. 1 as {0, . . . , 0}. The next channel may then combine K−1 0s and a single 1, and so on until the final channel combines K instances of N−1. In each case, the output of the device 102a to 102n may be a single voltage. This voltage may be small compared to the gaps in the quantisation scheme (e.g. 0.1 V) or it may be comparable to the gaps or larger (e.g. 1.5 V).

In each channel, the permutation of possible previous symbols calculated in the device 102a to 102n may be combined with / at a combiner 104a to 104n. By way of example, each combiner may be an adder. For example, if lo has a value of 0.8 V and the calculated distortion on a given channel is 0.1 V, the result of the combination may be 0.9 V.

The output of each combiner may then be fed to a respective decision circuit 106a to 106n (which may also be referred to as a quantiser). The decision circuit 106a to 106n may attempt to determine which symbol in the quantisation scheme the output of the combiner 104a to 104n corresponds to. This may be done by determining which symbol in the quantisation scheme is closest to the output of the combiner 104a to 104n. For example, the above example where the output of the combiner 104a to 104n is 0.9 V, the decision circuit 106a to 106n may determine that the correct symbol is 1 (corresponding to a voltage of 1 V). The output of a decision circuit is generally referred to as a decision, so the decision on each channel may be referred to for clarity as a channel decision. The set of channel decisions is a vector C₀.

The channel decisions C₀ may then be fed into a multiplexer 108. The multiplexer 108 may choose the element of C₀ that corresponds to the equalised (undistorted) symbol So that was originally transmitted. The means by which this selection may be made are discussed below.

The equalised symbol S₀ is the output of the DFE circuit from I₀ , and may also be referred to as the output decision. S₀ may also feed back via a tapped delay line 110. The number of taps in the delay line 110 may be K, the same as the number of previous symbols able to distort each incoming symbol. Therefore, when the signal I₀ is received, the delay line 110 may contain a set of K previous output decisions S₁, S₂, . . . , S_{K}, each accessible via one of the taps on the delay line 110. These previous output decisions may be fed back to the multiplexer 108. The multiplexer 108 may then select the element of C₀ from the channel with a permutation of voltages corresponding to the current contents of the delay line.

By way of illustration, suppose K=3 and the contents of the delay line are S₁=1, S₂=0, S₃=3 in the PAM-4 scheme. The circuit 100 may then have N^{K}=4³=64 channels. The first channel may correspond to the permutation {0, 0, 0}, the next {0, 0, 1}, and so on. Among these, there will be one channel with the permutation (1, 0, 3), matching the contents of the delay line 110. The multiplexer 108 can therefore select the channel decision from this channel to be the output decision S₀.

This method has a number of disadvantages. In particular, the number N^{K} of required channels (and consequently the required size of the multiplexer 108) may be large. This is particularly true if the rate at which symbols are transmitted is high, i.e. the delay spread of the data channel is significant with respect to the transmitted symbol interval, as this will tend to increase K, or if the number N of allowed symbols is large.

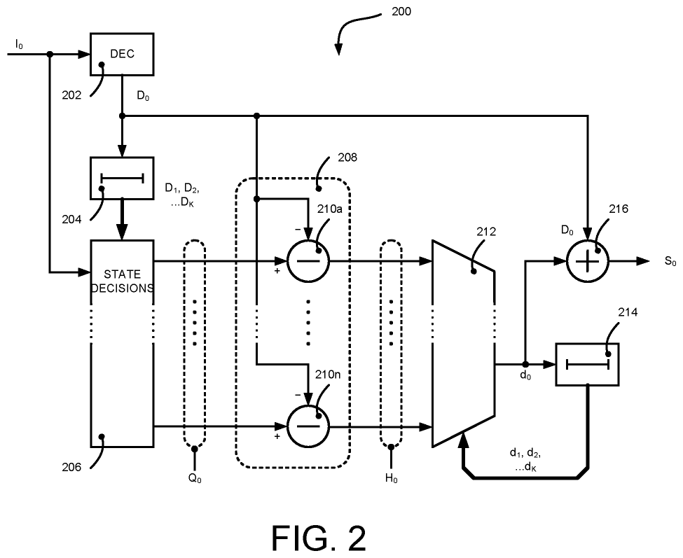

FIG. 2 shows a DFE circuit 200 according to an embodiment of the present invention. The circuit 200 may comprise an input decision circuit 202, a first tapped delay line 204, a state decision generator 206, a state complement generator 208 comprising combiners 210a to 210n, a multiplexer 212, a second tapped delay line 214, and a combiner 216.

Like the circuit 100 of FIG. 1, the eventual output of the circuit 200 is an output decision S₀ derived from an input signal I₀ received from a data channel. The input signal I₀ and the data channel may correspond to those described with reference to FIG. 1 above. In particular, the impulse response of the data channel may be used to calculate K and a set of coefficients Coeffs as described above.

The output decision S₀ may be written in the form D₀+d₀. D₀ is the input decision derived from the input signal I₀ at the input decision circuit 202 in the same manner as described above. d₀ is a correction term referred to herein as an equalisation complement. A goal of the circuit 200 is to find the correct value of dₒ to bring the input decision Dₒ, which may be incorrect due to distortion, to the correct decision S₀.

Alternatively, S₀ may correspond to D₀ and do combined by some method other than addition.

The range of possible values of d₀ is generally smaller than the range of possible values of D₀. For example, consider the PAM-4 scheme, in which Do may take the values (say) 0, 1, 2, or 3. The inventors have recognised that, in many cases, distortion from the data channel may distort the value of D₀ by +/−1, but not by +/−2. That is, if the originally transmitted symbol is 1, distortion on the data channel could, for example, distort the value of I₀ to 1.8, such that D₀ may be incorrectly determined to be 2; but the distortion will not be sufficient to lead to D₀ being determined to be 3. Reversing this, if D₀ is found to be 2, the correct decision S₀ must be 1, 2, or 3. There is no need to consider that S₀ could be 0. In this case, therefore, the value of d₀ must be 0 (no distortion) or +/−1.

More generally, this allows the introduction of a quantity Δ referred to herein as the equalisation range. Δ generally describes the maximum possible distortion of the input signal I₀. When attempting to find the correct value of d₀, there is no need to consider values with magnitude greater than Δ. This allows a reduction in the number of channels and the size of multiplexer required in circuit 200 compared to circuit 100. The details of how this simplification is implemented are described below.

In the circuit 200, the input signal I₀ may be split between two channels. One channel may arrive at the input decision generator 202, which may generate an input decision D₀ from the input signal I₀ as described above. The input decision D₀ is fed into the first tapped delay line 204, which has K taps and contains K previous input decisions D₁, D₂ , . . . , D_{K}.

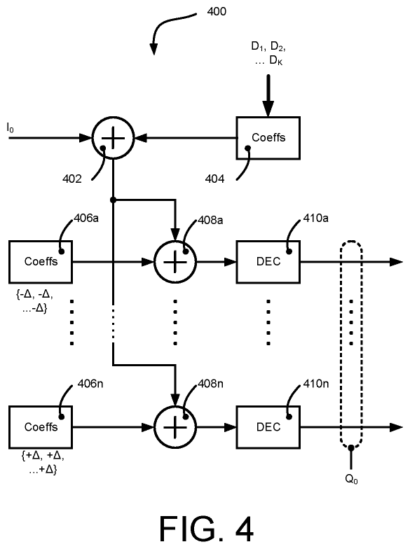

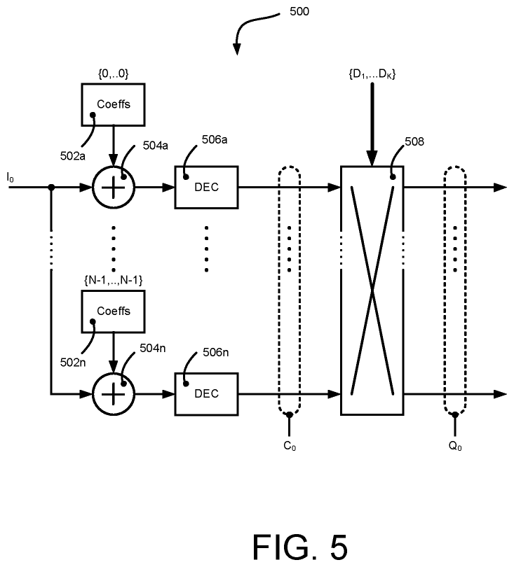

The input signal I₀ may also be fed into the state decision generator 206. Embodiments of the state decision generator 206 are described below with reference to FIGS. 4 and 5. The state decision generator 206 may take the input signal I₀ and the previous input decisions D₁, D₂, . . . , D_{K} as inputs, and may produce a vector Q₀, referred to as a vector of state decisions, as an output.

Each element of the vector Q₀ may have the form D₀+δₓ, where δₓ is a candidate value for d₀. δₓ may be calculated such that −Δ≤δₓ≤Δ. As a result, the number of elements of Q₀ may not be N^{K}, but may be the generally smaller quantity (2Δ+1)^{K}.

Examples of the operation of the state decision generator are described in more detail below with reference to FIGS. 4 and 5.

The vector Q₀ may then be one of two inputs to the state complement generator 208, with the other input being the input decision D₀. Each element of Q₀ is handled separately, so that the state complement generator has (2Δ+1)^{K} parallel channels. On each of these channels, the respective element of Q₀ is combined with D₀ at the combiners 210a to 210n, for example by subtraction. The output of the state complement generator is a vector H₀, which is referred to herein as the vector of state complements. Each element of H₀ is a candidate for the resulting equalisation complement d₀.

H₀ may then be fed into a multiplexer 212 that may perform a comparable role to the multiplexer 108 described above. In particular, multiplexer 212 may pick the correct value of d₀ from among the elements of H₀ based on the contents of a second tapped delay line 214. The second delay line 214 may accordingly contain the previous K resulting equalisation complements, d₁, d₂, . . . , d_{K}.

It is noted that multiplexer 212 may be smaller than multiplexer 108, even for equivalent values of N and K. This is because multiplexer 108 requires N^{K} input channels, while multiplexer 212 requires only (2Δ+1)^{K} input channels.

The output of the multiplexer 212 is the resulting equalisation complement d₀, which is combined with the input decision D₀ at the combiner 216 (for example, by addition) to arrive at the output decision S₀.

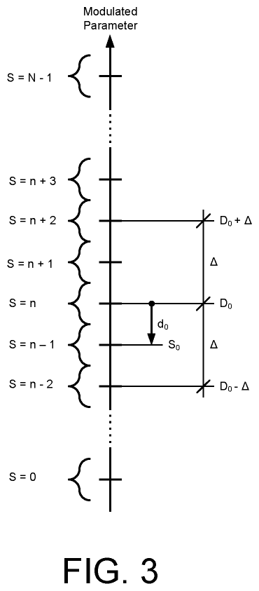

FIG. 3 illustrates the equalisation range Δ relative to the full range of possible symbols transmitted along the data channel. Transmission along a data channel is often accomplished by some form of modulation; for example, pulse amplitude modulation. Let the modulated parameter be S. S may have N quantised levels, referred to as symbols, labelled in FIG. 3 by the numerals 0 to N−1. This is illustrated on the vertical axis of FIG. 3.

The input decision D₀ will be one of the quantised levels as S, such as, for example, level n. The equalisation range Δ may then be, for example, 2. The set of possible values of the correct decision So then runs from D₀−Δ to D₀+Δ. In the example of FIG. 3, therefore, the range of potential values of S₀ is n−2 to n+2. The value of do will then be a value within the range −Δ to +Δ; in FIG. 3, do is illustrated as −1.

FIG. 3 therefore illustrates an advantage of the present invention, namely that only the levels n−2 to n+2 need be considered as potential values of S₀, rather than the full range of S from 0 to N−1. This results in the reduction of the number of channels, and associated reduction in power consumption, referred to above.

FIG. 4 shows an example embodiment 400 of the state decision generator 206 described above. As illustrated in FIG. 2, the inputs to the state decision generator 400 may be the input signal I₀ and the previous input decisions D₁, D₂, . . . , D_{K}. The previous input decisions D₁, D₂, . . . , D_{K} may be combined at a device 404 with the coefficients Coeffs calculated from the data channel impulse response to produce a resulting voltage. This resulting voltage may be combined with the input signal I₀ at a combiner 402 (which may for example be an adder).

The signal from the combiner 402 may then be split into (2Δ+1)^{K} parallel channels. Each channel may have a device 406a to 406n which combines a set of K voltages using the coefficients Coeffs. Each of the K voltages may have an integer value between −Δ and Δ, such that every possible permutation of integer voltages within this range is covered between all (2Δ+1)^{K} channels. The voltage from the device 406a to 406n may then be combined with the voltage from the combiner 402 at a combiner 408a to 408n (which may for example be an adder). The output of the combiner 408a to 408n may then feed into a decision circuit 410a to 410n of the kind described above. The decisions from each of the decision circuits 410a to 410n may then be the elements of the vector Q0 described above.

It is noted that, in this embodiment, the multiplexer 212 may select which channel has the correct value of d₀ by selecting the channel with a permutation of voltages corresponding to the current contents of the second tapped delay line 214.

FIG. 5 shows an alternative example embodiment 500 of the state decision generator 206 described above. In the state decision generator 500, the input signal I₀ may be split into N^{K} parallel channels. Each channel may have a device 502a to 502n that uses the coefficients Coeffs to linearly combine a permutation of K voltages, each voltage being an integer voltage from 0 to N−1, such that each possible permutation of such voltages is present on one of the parallel channels.

On each channel, the voltage from the device 502a to 502n may be combined with the input signal I₀ at a combiner 504a to 504n (which may for example be an adder). The output of the combiner 504a to 504n may then enter a decision circuit 506a to 506n, which may output a decision referred to herein as a channel decision. The channel decisions may then be the elements of the vector C₀.

It is noted that the vector C₀ produced in this manner may be identical to the vector C₀ described above with reference to FIG. 1.

The vector C₀ may then be the input to a multiplexer 508, referred to herein as the decision multiplexer, which may also receive as a second input the previous input decisions D₁, D₂, . . . , D_{K}. The decision multiplexer 508 may select a number (24Δ+1)^{K} of the N^{K} parallel channels, and consequently has (2Δ+1)^{K} output channels. This corresponds to selecting (2Δ+1)^{K} elements of the NK element vector C₀.

In the selection process, the previous input decisions D₁, D₂, . . . , D_{K} may be applied to the control input of the decision multiplexer 508. The decision multiplexer 508 may then select elements of C₀ corresponding to the set of previous channel decisions {D₁+β₁, D₂+β₂, . . . , D_{K}+β_{K}} , where −Δ≤βᵢ≤Δ for i=1. . . K.

The output of the decision multiplexer 508 may then be the vector Q₀ described above. The multiplexer 212 may then select the correct channel, arriving at the output decision S₀, in the same fashion as described above with reference to FIG. 2.

It is emphasised that, in embodiments described above, the coefficients Coeffs and any calculations performed with them can be pre-calculated. For example, in FIG. 5, the calculations of the devices 502a to 502n do not depend on the input signal I₀, and may consequently be carried out in advance. Such calculations need be updated only when there is a change in the data channel, for example a gradual change in the coefficients Coeffs as a result of aging of the channel.

As a result, it is often the case that the factor limiting the maximum symbol rate that can be equalised by the circuit 200 is the time taken for the multiplexer 212 to select the resulting equalisation complement d₀ from among the elements of H₀. Generally speaking, in implementations described above, it may be that this selection must be performed by the multiplexer 212 within a single symbol interval. The fastest possible selection by the multiplexer may therefore limit the fastest symbol rate that can be handled by the circuit 200.

This limit can be relaxed by splitting the work of the multiplexer 212 across M parallel processing branches. For example, M resulting equalisation complements d₀, d₁, . . . , d_{M-1} may be determined in parallel rather than sequentially.

In the m-th processing branch the resulting equalisation complement dm may be selected from the vector Hₘ on the basis of the previous K resulting equalisation complements, dₘ₊₁, dₘ₊₂, . . . , dₘ₊ₖ by the same means described above regarding multiplexer 212. In its turn each resulting equalisation complement dₘ₊ᵢ, I=1 . . . K may be selected from the vector Hₘ₊ᵢ on the basis of the K previous resulting equalisation complements, dₘ₊ᵢ₊₁, dₘ₊ᵢ₊₂, . . . , dₘ₊ᵢ₊ₖ. After the series of recursive substitutions dm may be expressed as a combination of the L+1 vectors Hₘ, Hₘ₊₁, . . . H_{m+L} and K resulting equalisation complements, d_{m+L+1}, d_{m+L+2}, . . . , d_{m+L+K}, where L is a number referred to as the look-ahead factor. The results of the combination for each possible permutation of K previous resulting equalisation complements, d_{m+L+1}, d_{m+L+2}, . . . , d_{m+L+K}, are the elements of the vector Fₘ. This vector has (2Δ+1)^{K} elements, and each element represents a value for dₘ for a specific permutation of K resulting equalisation complements, d_{m+L+1}, d_{m+L+2}, . . . , d_{m+L+K}. Thus, dm may be selected from Fm by indexing its element with previous K resulting equalisation complements, d_{m+L+1}, d_{m+L+2}, . . . , d_{m+L+K}.

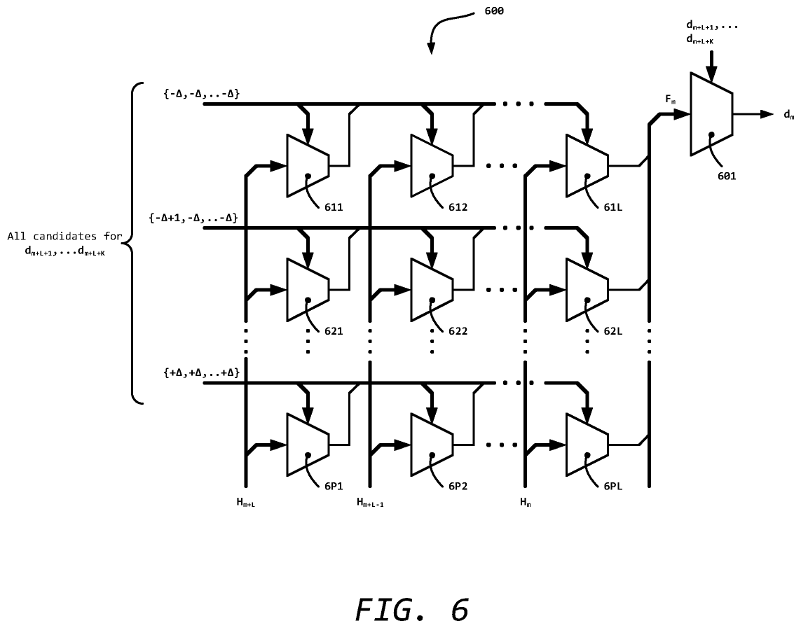

FIG. 6 illustrates an example embodiment of the m-th processing branch 600 in such an arrangement, where 0≤m≤M−1. M copies of the branch 600 may be required to implement the method discussed below. The final output of the m-th branch 600 is the m-th equalisation complement dₘ.

Each branch 600 may use an array of additional multiplexers 611 to 6PL. The number of additional multiplexers may be P*(L+1), where P=(2Δ+1)^{K}. The final multiplexer 601 then selects the equalisation complement dₘ.

The array of additional multiplexers 611 to 6PL may be arranged into P rows and L+1 columns. The rightmost column, containing multiplexers 61L to 6PL, may receive the vector Hₘ as an input. This vector may correspond to the vector H₀ introduced above, but is the version of H₀ produced while processing the earlier input signal Iₘ rather than the current input signal I₀. (For example, the input signal immediately preceding I₀ would be labelled I₁, and a vector H₁ would be generated while processing I₁.) The vectors provided to the remaining columns may be Hₘ₊₁, Hₘ₊₂, . . . , H_{m+L}.

Each row of the array receives a combination of K voltages within the range −Δ to Δ, which are fed through the array as shown in FIG. 6 to provide control inputs for the rightmost column of the multiplexers 61L to 6PL. The primary input to the final multiplexer 601 is then a vector Fₘ comprising components taken from the vector Hₘ. The final multiplexer 601 then selects dₘ from among the components of Fₘ on the basis of previous K resulting equalisation complements, d_{m+L+1}, d_{m+L+2}, . . . , d_{m+L+K}. by the same means described above regarding multiplexer 212.

The result of this process is that each resulting equalisation complement dₘ need not be selected within a single symbol interval, but can instead be selected over a period of L+1 symbol intervals, rather than just 1. This provides an enhancement in the maximum symbol rate by a factor of L+1.

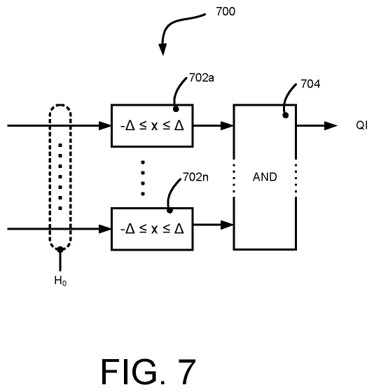

FIG. 7 shows an example of a quality estimator (QE) circuit 700 that may be used in combination with embodiments described above, for example the circuit 200. The QE circuit 700 may receive the vector H₀ described above as an input. Each of the (2Δ+1)^{K} components of H₀ may pass through a range comparator 702a to 702n that ascertains whether or not that component falls within the range −Δ to Δ. As described above, each of the components of Ho is a candidate for the equalisation complement d₀, which must have a magnitude between −Δ and Δ, and so correct operation pf the circuit 200 would result in each component of H₀ falling within this range.

The outputs of the range comparators 702a to 702n may then be fed into a device 704 referred to herein as an overflow combiner. The overflow combiner 704 may for example be an AND circuit, giving a positive output (e.g. logical 1) if all (2Δ+1)^{K} channels fall within the range −Δ to Δ, and a negative output (e.g. logical 0) if any do not.

The output QI of the overflow combiner 704 may then be monitored. Detection of a negative output indicates that at least one component of H₀ falls outside the equalisation range, further indicating that equalisation is not being performed correctly by the circuit 200.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of decision feedback equalisation (DFE) of an input signal, comprising:
calculating an equalisation range,
receiving the input signal;
generating an input decision from the input signal;
generating a plurality of state decisions from the input signal using the equalisation range and one or more previous input decisions;
combining the input decision with the plurality of state decisions to generate a plurality of state complements;
selecting a resulting complement from among the plurality of state complements based on one or more previous resulting complements, wherein a number of the one or more previous resulting complements is equal to a number of the one or more previous input decisions; and
combining the resulting complement with the input decision to generate an output decision.

2. The method of claim 1, wherein the equalisation range is calculated from an impulse response of the data channel.

3. The method of claim 1, wherein the input decision corresponds to a voltage level.

4. The method of claim 1, wherein the input decision corresponds to a level of a pulse amplitude modulation scheme.

5. The method of claim 4, wherein the pulse amplitude modulation scheme is PAM-4.

6. The method of claim 1, wherein generating the plurality of state decisions comprises:
linearly combining the one or more previous input decisions using a set of coefficients calculated from characteristics of the data channel to obtain a first value;
in each of a plurality of parallel channels:
linearly combining a set of values using the set of coefficients to obtain a channel value, wherein each value in the set of values has magnitude less than or equal to the equalisation range, each value corresponding to a level of a pulse amplitude modulation scheme;
combining the input signal, the first value and the channel value to produce a combined value;
generating a channel decision from the combined value;
wherein the plurality of state decisions comprises each of the channel decisions.

7. The method of claim 6, wherein the equalisation range has a value Δ, the number of the previous state complements and the number of the previous input decisions is K, and the number of the plurality of state decisions is (2Δ+1)^{K}.

8. The method of claim 1, wherein generating the plurality of state decisions comprises:
in each of a plurality of parallel channels:
linearly combining a set of values using a set of coefficients calculated from characteristics of the data channel to obtain a channel value, wherein each value in the set of values has magnitude less than or equal to the equalisation range, each value corresponding to a level of a pulse amplitude modulation scheme;
combining the input signal with the channel value to produce a combined value; and
generating a channel decision from the combined value;
wherein the plurality of state decisions comprises each of the channel decisions.

9. The method of claim 8, wherein a number of distinct symbols that may be received as part of the input signal is N, the number of the previous state complements and the number of the previous input decisions is K, the number of the plurality of state decisions is N^{K}, and the equalisation range has a value Δ; the method further comprising selecting (2Δ+1)^{K} of the plurality of state decisions to be combined with the input decision.

10. The method of claim 1, wherein the state complement is further based on the equalisation range.

11. The method of claim 1, wherein each step of combining refers to either addition or subtraction.

12. The method of claim 1, wherein selecting the resulting complement comprises combining the plurality of state complements with the equalisation range as well as with the one or more previous resulting complements.

13. The method of claim 1, further comprising:
for each of the plurality of state complements, determining whether a magnitude of the state complement is less than or equal to the equalisation range; and
generating a positive outcome if the magnitude of the state complement is less than or equal to the equalisation range, or a negative outcome otherwise.

14. The method of claim 13, further comprising combining the positive and negative outcomes.

15. The method of claim 14, wherein said combining comprises the use of a logical conjunction circuit, such that the overall outcome is positive if every state complement has magnitude less than or equal to the equalisation range, and negative otherwise.

16. A method of selecting a resulting complement, comprising:
calculating an equalisation range,
selecting a first plurality of state complements from one or more previous state complements based on the equalisation range;
selecting a second plurality of state complements from a plurality of current state complements based on the first plurality of state complements;
selecting the resulting complement from among the second plurality of state complements based on one or more previous resulting complements.

17. A decision feedback equalisation (DFE) circuit configured to receive an input signal, the DFE circuit comprising:
an input decision circuit configured to generate an input decision from the input signal;
a state decision generator configured to generate a plurality of state decisions from the input signal using an equalisation range and one or more previous input decisions;
a state complement generator configured to generate a plurality of state complements by combining the input decision with the plurality of state decisions;
a multiplexer configured to select a resulting complement from among the plurality of state complements based on one or more previous resulting complements, wherein a number of the previous resulting complements is equal to a number of the previous input decisions; and
a combiner configured to combine the state complement with the input decision to generate an output decision.
